(19) United States
(12) Patent Application Publication
(10) Pub. No.: US 2007/0193633 A1
(43) Pub. Date: Aug. 23, 2007

(54) SELF-CONTAINED CHECK VALVE MODULE

(75) Inventors: Julie C. Howell, Indian Trail, NC (US); Raymond E. Cellemme JR., Matthews, NC (US)

Correspondence Address: ADAMS EVANS P.A., Suite 2350 Charlotte Plaza, 201 South College Street, CHARLOTTE, NC, 28244, US

(73) Assignee: CONBRACO INDUSTRIES, INC., Matthews, NC (US)

(21) Appl. No.: 11/307,706

(22) Filed: Feb. 17, 2006

(51) Int. Cl. F16K 15/06

(52) U.S. Cl. 137/542

(57) ABSTRACT

A check valve module for use in a backflow preventer. The check valve module includes a housing, a valve element positioned in the housing and moveable between a closed position and an open position, and a spring retainer. The spring retainer includes at least one outwardly extending projection adapted to be received and secured in a recess positioned on an end of the housing. A spring is positioned between the spring retainer and the valve element for biasing the valve element towards the closed position and biasing the spring retainer to a locking position where the projection is secured in the recess.

### TECHNICAL FIELD AND BACKGROUND OF THE INVENTION

The present invention relates to the field of backflow preventers. In particular, the invention relates to a self-contained check valve module for use in backflow preventers.

Check valve modules are well known and are widely used to control backflow into a fluid supply of fluids carrying undesirable contaminants. These valves are self-contained, and are similar in that they contain spring-loaded members that are biased toward the valve-closed position until fluid pressure acting on the spring-loaded members forces the valves open. Typically, a backflow preventer utilizes two check valve modules for preventing the backflow of a fluid.

In a conventional design, the spring-loaded member is a poppet-type check in which the movement of the spring-loaded member is linear and remains in the fluid path. The energy required to open these check valve modules is provided by the fluid and is created at the source by, for example, a pump. The pressure required to open a check valve is established by governmental regulation and provides a minimum degree of protection against reverse flow.

Conventional check valve modules incorporate a spring retainer that is rigidly attached to the seat or other part of the backflow preventer or check valve. Thus, special tools must be used to assemble or disassemble the modules when the spring-loaded member needs to be repaired or replaced. Additionally, over time the modules are susceptible to undesirable contaminants that make disassembling the modules difficult, and in some cases disassembly results in the breakage of the module.

Accordingly, there is a need for a self-contained check valve module that incorporates a removable spring retainer that is held in position by the spring, and that can be easily removed without tools.

### SUMMARY OF THE INVENTION

Therefore it is an object of the invention to provide a check valve module that has a removable spring retainer.

It is another object of the invention to provide a check valve module that has a spring retainer held in position by the spring.

It is another object of the invention to provide a check valve module that has a spring retainer that can be removed without the use of tools.

It is another object of the invention to provide a check valve module that has a spring retainer that can be removed easily without the fear of breakage.

These and other objects of the present invention are achieved in the preferred embodiments disclosed below by providing a check valve module. The check valve module includes a housing, a valve element positioned in the housing and moveable from a closed position to an open position, and a spring retainer having at least one projection extending outwardly therefrom and adapted to be received and secured in a recess positioned on an end of the housing. The module further includes a spring positioned between the spring retainer and the valve element for biasing the valve element towards the closed position and biasing the spring retainer to a locking position where the at least one projection is secured in the recess.

According to another preferred embodiment of the invention, the valve element includes an annular head and a stem extending outwardly from a bottom surface of the head.

According to another preferred embodiment of the invention, a recess is formed in a top surface of the head for receiving a seat disc adapted for being pressed against the housing to provide a seal between the housing and the head.

According to another preferred embodiment of the invention, the end of the housing includes a pair of opposing sidewalls separated by a pair of opposing slots, each of the sidewalls having a groove therein extending the length of the sidewalls and cooperating with the slots for receiving the at least one projection therein.

According to another preferred embodiment of the invention, the recess is positioned in a respective one of the sidewalls adjacent to and cooperating with the respective groove for receiving the at least one projection.

According to another preferred embodiment of the invention, the spring retainer is secured to the housing by positioning the at least one projection in a respective slot and rotating the spring retainer such that the at least one projection is moved into a respective groove and into the recess to secure the spring retainer to the housing.

According to another preferred embodiment of the invention, the spring retainer further includes a flange, and wherein the at least one projection extends outwardly from the flange.

According to another preferred embodiment of the invention, the spring retainer further includes a channel for receiving a portion of the spring therein.

According to another preferred embodiment of the invention, a check valve module includes a housing having a body and a pair of sidewalls extending outwardly therefrom, each of the sidewalls including a recess adjacent to and cooperating with a groove; a valve assembly positioned in the housing and moveable from a closed position to an open position; and a spring retainer having a flange and a pair of projections extending outwardly therefrom, the projections adapted for being received and secured in the recesses. The module further including a spring positioned between the spring retainer and the valve assembly for biasing the valve assembly towards the closed position and biasing the spring retainer to a locking position where the projections are secured in the recesses.

According to another preferred embodiment of the invention, the valve assembly includes a poppet having an annular head and a stem extending outwardly from a bottom surface of the head.

According to another preferred embodiment of the invention, the valve assembly further includes a seat disc positioned in a recess in a top surface of the head for being in sealing engagement with the housing.

According to another preferred embodiment of the invention, the spring retainer further includes a shank integrally-formed with and extending outwardly from the flange and adapted for rotating the spring retainer.

According to another preferred embodiment of the invention, the spring retainer includes an axially extending bore therethrough for receiving a portion of the valve assembly therethrough, the bore providing a guide and allowing the valve assembly to move between the closed and open positions.

According to another preferred embodiment of the invention, the spring retainer further includes a channel for receiving and securing a portion of the spring therein, wherein the spring is positioned around the stem and between the head and the channel to bias the head in sealing engagement with the housing.

According to another preferred embodiment of the invention, a backflow preventer for controlling fluid flow includes a valve housing having an interior for permitting fluid flow therethrough, and at least one check valve module disposed within the interior of the valve housing for controlling the fluid flow therethrough. The check valve module includes a housing; a valve element positioned in the housing and moveable from a closed position to an open position; and a spring retainer having at least one projection extending outwardly therefrom and adapted to be received and secured in a recess positioned on an end of the housing. The check valve module further including a spring positioned between the spring retainer and the valve element for biasing the valve element towards the closed position and biasing the spring retainer to a locking position where the at least one projection is secured in the recess.

According to another preferred embodiment of the invention, a method for assembling a check valve module includes the step of providing a check valve module having a housing, a valve element, a spring retainer having at least one projection extending outwardly therefrom, and a spring. The method further includes the steps of positioning the valve element in the housing, positioning the spring over a stem of the valve element, and positioning the spring retainer in alignment with the housing such that the spring rests between the valve element and the spring retainer. Further, the method includes the steps of compressing the spring between the valve element and the spring retainer, rotating the spring retainer, and securing the at least one projection in a recess of the housing.

According to another preferred embodiment of the invention, the step of compressing the spring includes the step of pressing the spring retainer towards the housing until the at least one projection rests against a body of the housing.

According to another preferred embodiment of the invention, further including the step of releasing the spring retainer to allow the spring to expand and force the at least one projection into the recess.

According to another preferred embodiment of the invention, the step of rotating the spring retainer includes the step of moving the at least one projection into a groove of the housing cooperating with the recess.

According to another preferred embodiment of the invention, the housing includes a body and a pair of sidewalls, separated by opposing slots, extending outwardly therefrom, each of the sidewalls including a recess adjacent to and cooperating with a groove, and the spring retainer includes two projections extending outwardly from a flange of the spring retainer.

According to another preferred embodiment of the invention, the steps of compressing, rotating, and securing include the steps of pressing the spring retainer towards the housing until the two projections are positioned within the slots and against the body, moving the two projections into the grooves until the projections are positioned below the recesses, releasing the spring retainer and allowing the spring to expand and force the projections upwardly into the recesses.

### BRIEF DESCRIPTION OF THE DRAWINGS

The invention is described below in conjunction with the accompanying drawing figures in which:

FIG. 1 is a perspective view of a check valve module according to an embodiment of the invention;

FIG. 2 is another perspective view of the check valve module of FIG. 1;

FIG. 3 is a side view of the check valve module of FIG. 1;

FIG. 4 shows the check valve module of FIG. 1 installed in a check valve housing;

FIG. 5 is a cross-section of the check valve module of FIG. 1; and

FIG. 6 is an exploded view of the check valve module of FIG. 1.

### DESCRIPTION OF THE PREFERRED EMBODIMENT AND BEST MODE

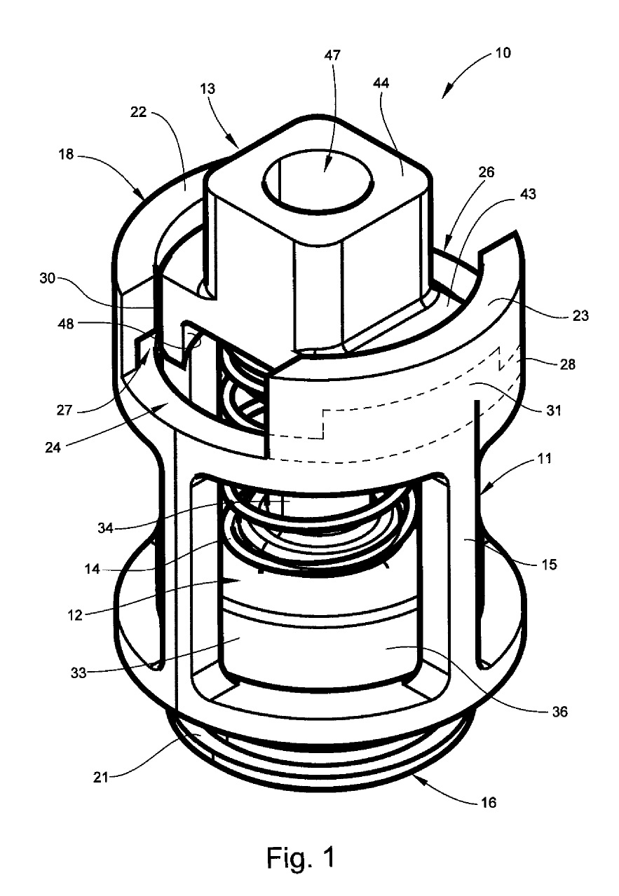

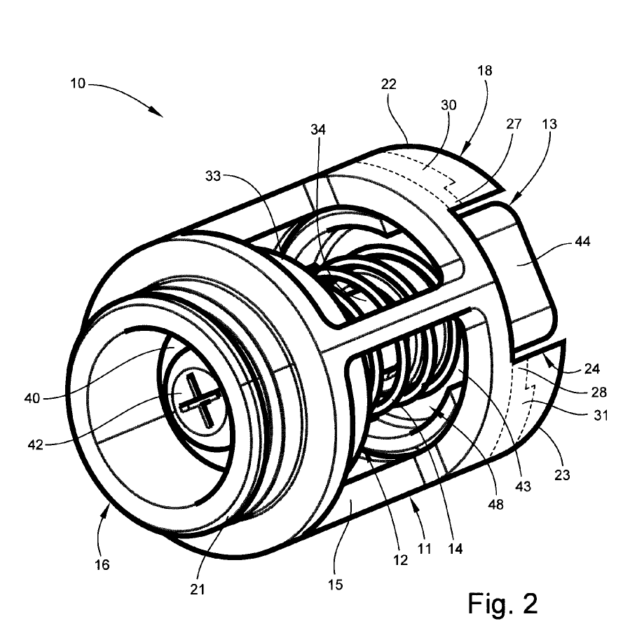

Referring now specifically to the drawings, a check valve module according to an embodiment of the invention is illustrated in FIGS. 1-3 and shown generally at reference numeral 10. The module 10 generally includes a valve housing 11, a valve assembly 12 positioned within the housing 11 and moveable from a closed position to an open position, a spring retainer 13 removably attached to the housing 11, and a spring 14 positioned between the spring retainer 13 and the valve assembly 12 to bias the valve assembly 12 towards a closed position.

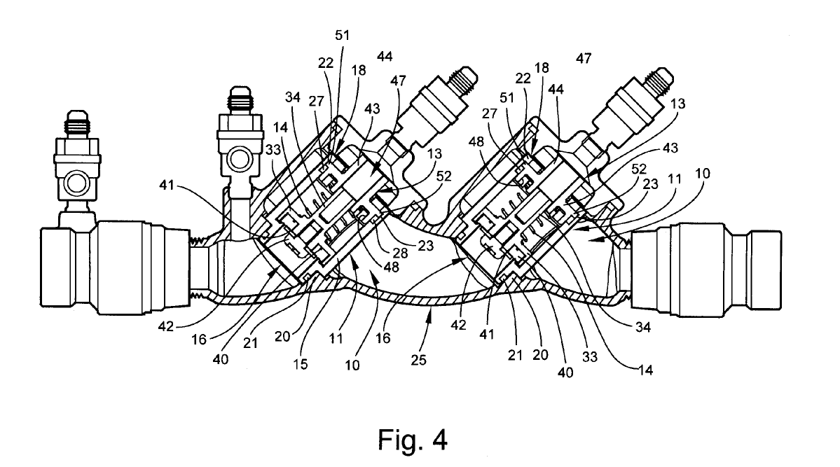

As illustrated, the housing 11 forms a cage-like structure 15 around the valve assembly 12 and includes a first end 16 and an opposed second end 18. The first end 16 is positioned in sealing engagement with a seat 20 of a check valve housing 25, as shown in FIG. 4, and includes a seal, such as an O-ring 21 to prevent leakage therebetween.

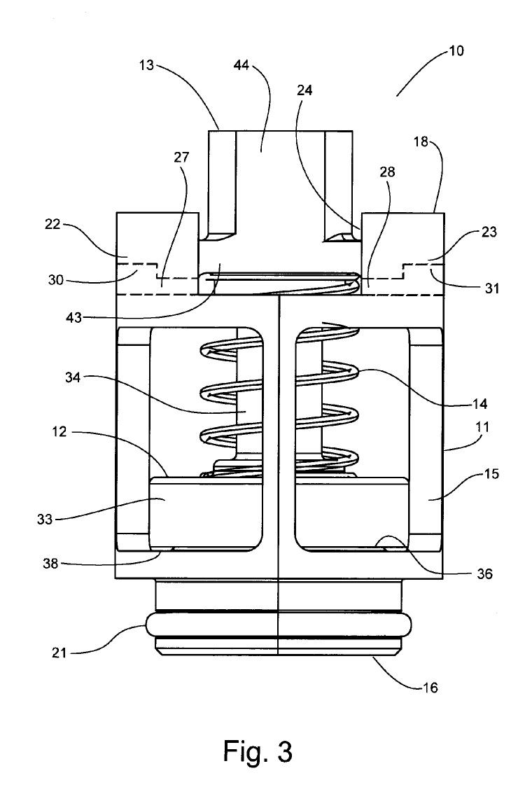

As is best shown in FIGS. 1 and 3, the second end 18 includes a pair of sidewalls 22 and 23 separated by opposing slots 24 and 26. The sidewalls 22 and 23 include respective grooves 27 and 28 and respective recesses 30 and 31. The groove 27 extends the entire length of the sidewall 22, and the groove 28 extends the entire length of the sidewall 23. Recess 30 is adjacent to and integrally-formed with the groove 27 and positioned substantially in the center of the sidewall 22, and recess 31 is adjacent to and integrally-formed with the groove 28 and positioned substantially in the center of the sidewall 23.

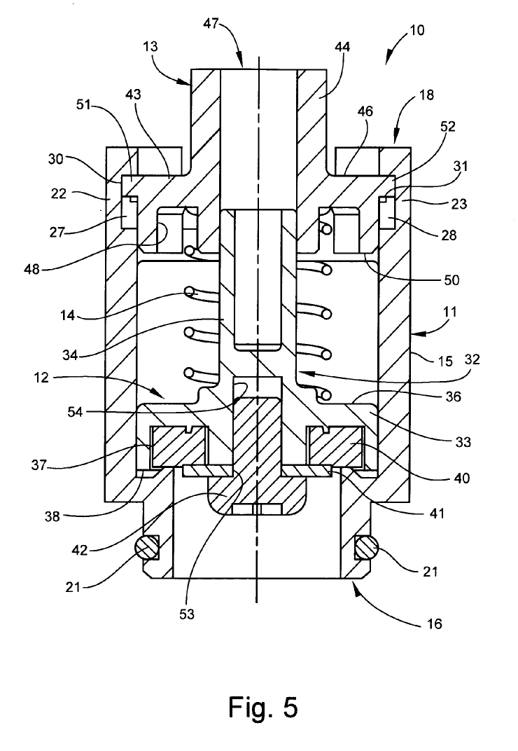

Referring now to FIG. 5, the valve assembly 12 includes a valve element, such as a poppet 32, having a annular head 33 and a stem 34 extending outwardly from a bottom surface 36 of the head 33. A recess 37 is formed in a top surface 38 of the head 33 and is adapted to receive a seat disc 40. A retaining washer 41 secures the seat disc 40 within the recess 37 and is secured to the head 33 by a fastener 42. The seat disc 40 may be made of any material, such as rubber, suitable for providing a seal between the valve assembly 12 and the housing 11.

The spring retainer 13 includes a flange 43, an integrally-formed shank 44 extending outwardly from a bottom surface 46 of the flange 43, and an axially-extending bore 47 extending therethrough for receiving the stem 34 of the poppet 32, thereby allowing the valve assembly 12 to be guided as it moves between the closed and open positions. A channel 48 is formed in the flange 43 to receive and secure the spring 14 in position between the spring retainer 13 and the head 33. A pair of projections, such as locking tabs 51 and 52, are positioned on opposing sides of the flange 43 and are adapted for being received by the grooves 27 and 28 and recesses 30 and 31 formed in the sidewalls 22 and 23 to secure the spring retainer 13 to the housing 11.

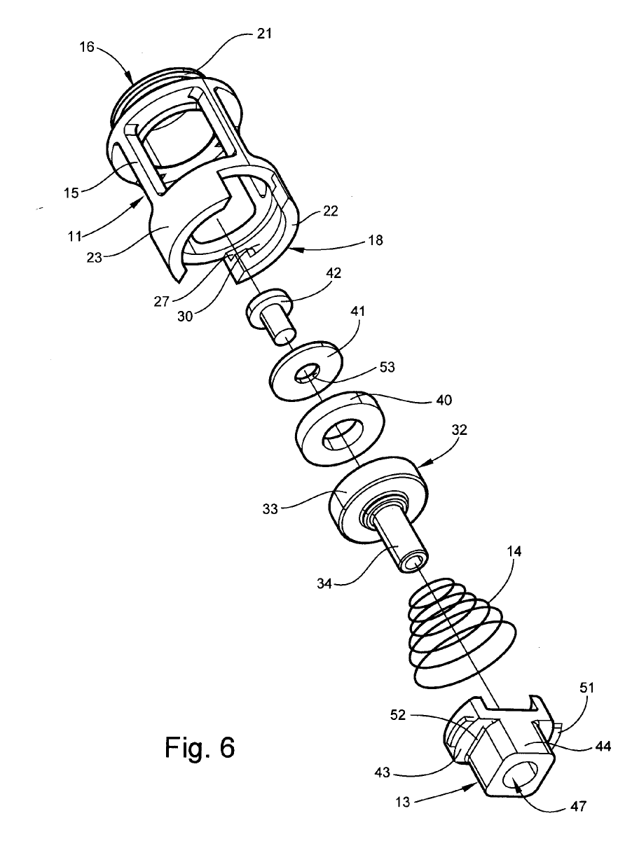

Referring to FIG. 6, the module 10 is assembled by first assembling the valve assembly 12. The seat disc 40 is positioned in the recess 37 of the head 33 of the poppet 32. The retaining washer 41 is then placed over the seat disc 40 such that an aperture 53 in the washer 41 is aligned with a bore 54 positioned in a center of the head 33. Next, the fastener 43 extends through the aperture 53 and into the bore 54, thereby securing the washer 41 to the head 33 and the seat disc 40 in the recess 37.

The valve assembly 12 is then positioned within the housing 111 by sliding the valve assembly 12 into the housing 111 from the second end 18 to the first end 16. Next, the spring 14 is slid over the stem 34 of the poppet 33. Finally, the spring retainer 13 is positioned such that the flange 43 is aligned with the housing 11, the spring 14 is positioned in the channel 48 of the flange 43, and the locking tabs 51 and 52 are aligned with respective slots 24 and 26.

Once the spring retainer 13 is in position, the spring retainer 13 is pushed down into the housing 11 between the sidewalls 22 and 23, compressing the spring 14 until the locking tabs 51 and 52 rest against the body 17 of the housing 111 within the slots 24 and 26. The spring retainer 13 is then rotated using the shank 44, thereby moving the locking tabs 51 and 52 into the grooves 27 and 28 of the sidewalls 22 and 23. The spring retainer 13 is rotated until the locking tabs 51 and 52 are aligned with respective recesses 30 and 31. The spring retainer 13 is then released to allow the spring 14 to expand and force the locking tabs 51 and 52 into the recesses 30 and 31, thereby securing the spring retainer 13 to the housing 11. As illustrated in FIG. 4, once the module 10 is assembled, the module 10 can be positioned in the check valve housing 25 to provide a backflow prevention means.

To remove the spring 14 and valve assembly 12 from the housing 11, the spring retainer 13 is pushed downwardly towards the body 17, compressing the spring 14, to disengage the locking tabs 51 and 52 from the recesses 30 and 31 and position the locking tabs 51 and 52 in the grooves 27 and 28. The spring retainer 13 is then rotated until the locking tabs 51 and 52 are positioned in the slots 24 and 26. The spring retainer 13 is then removed from the housing 11, allowing the spring 14 and valve assembly 12 to be removed.

A check valve module is described above. Various details of the invention may be changed without departing from its scope. Furthermore, the foregoing description of the preferred embodiments of the invention and best mode for practicing the invention are provided for the purpose of illustration only and not for the purpose of limitation.

What is claimed is:

1. A check valve module, comprising:
(a) a housing;
(b) a valve element positioned in the housing and moveable from a closed position to an open position;
(c) a spring retainer having at least one projection extending outwardly therefrom and adapted to be received and secured in a recess positioned on an end of the housing; and
(d) a spring positioned between the spring retainer and the valve element for biasing the valve element towards the closed position and biasing the spring retainer to a locking position where the at least one projection is secured in the recess.

2. The check valve module according to claim 1, wherein the valve element includes an annular head and a stem extending outwardly from the head.

3. The check valve module according to claim 2, wherein the head includes a recess for receiving a seat disc adapted for being pressed against the housing to provide a seal between the housing and the head.

4. The check valve module according to claim 1, wherein the end of the housing includes a pair of opposing sidewalls separated by a pair of opposing slots, each of the sidewalls having a groove therein extending the length of the sidewalls and cooperating with the slots for receiving the at least one projection therein.

5. The check valve module according to claim 4, wherein the recess is positioned in a respective one of the sidewalls adjacent to and cooperating with the respective groove for receiving the at least one projection.

6. The check valve module according to claim 5, wherein the spring retainer is secured to the housing by positioning the spring retainer between the sidewalls such that the at least one projection is positioned in a respective slot, the spring retainer being rotated such that the at least one projection is moved into a respective groove and into the recess.

7. The check valve module according to claim 1, wherein the spring retainer further includes a flange, and wherein the at least one projection extends outwardly from the flange.

8. The check valve module according to claim 1, wherein the spring retainer further includes a channel for receiving a portion of the spring therein.

9. A check valve module, comprising:
(a) a housing having a body and a pair of sidewalls extending outwardly therefrom, each of the sidewalls including a recess adjacent to and cooperating with a groove;
(b) a valve assembly positioned in the housing and moveable from a closed position to an open position;
(c) a spring retainer having a flange and a pair of projections extending outwardly therefrom, the projections adapted for being received and secured in the recesses; and
(d) a spring positioned between the spring retainer and the valve assembly for biasing the valve assembly towards the closed position and biasing the spring retainer to a locking position where the projections are secured in the recesses.

10. The check valve module according to claim 9, wherein the valve assembly includes a poppet having an annular head and a stem extending outwardly from the head.

11. The check valve module according to claim 10, wherein the valve assembly further includes a seat disc positioned in a recess of the head for providing a seal between the valve assembly and the housing.

12. The check valve module according to claim 9, wherein the spring retainer further includes a shank integrally-formed with and extending outwardly from the flange, the flange being adapted for rotating the spring retainer.

13. The check valve module according to claim 9, wherein the spring retainer includes an axially extending bore therethrough for receiving a portion of the valve assembly, the bore providing a guide and allowing the valve assembly to move between the closed and open positions.

14. The check valve module according to claim 10, wherein the spring retainer further includes a channel for receiving and securing a portion of the spring therein, wherein the spring is positioned around the stem and between the head and the channel to bias the head in sealing engagement with the housing.

15. A backflow preventer for controlling fluid flow, comprising:
(a) a valve housing having an interior for permitting fluid flow therethrough;
(b) at least one check valve module disposed within the interior of the valve housing for controlling the fluid flow therethrough, the check valve module comprising:
(i) a housing;
(ii) a valve element positioned in the housing and moveable from a closed position to an open position;
(iii) a spring retainer having at least one projection extending outwardly therefrom and adapted to be received and secured in a recess positioned on an end of the housing; and
(iv) a spring positioned between the spring retainer and the valve element for biasing the valve element towards the closed position and biasing the spring retainer to a locking position where the at least one projection is secured in the recess.

16. The backflow preventer according to claim 15, wherein an end of the housing is in sealing engagement with a seat of the valve housing.

17. The backflow preventer according to claim 15, wherein the valve element includes an annular head and a stem extending outwardly from the head, the head including a recess for receiving a seat disc adapted for being pressed against the housing to provide a seal between the housing and the head.

18. The backflow preventer according to claim 15, wherein the end of the housing includes a pair of opposing sidewalls separated by a pair of opposing slots, each of the sidewalls having a groove therein extending the length of the sidewalls and cooperating with the slots for receiving the at least one projection therein.

19. The backflow preventer according to claim 18, wherein the recess is positioned in a respective one of the sidewalls adjacent to and cooperating with the respective groove for receiving the at least one projection.

20. The backflow preventer according to claim 19, wherein the spring retainer is secured to the housing by positioning the spring retainer between the sidewalls such that the at least one projection is positioned in a respective slot, the spring retainer being rotated such that the at least one projection is moved into a respective groove and into the recess.

21. The backflow preventer according to claim 15, wherein the spring retainer further includes a flange, and wherein the at least one projection extends outwardly from the flange.

22. The backflow preventer according to claim 15, wherein the spring retainer further includes a channel for receiving a portion of the spring therein.

23. A method for assembling a check valve module, comprising the steps of:
(a) providing a check valve module, comprising:
(i) a housing;
(ii) a valve element;
(iii) a spring retainer having at least one projection extending outwardly therefrom; and
(iv) a spring;
(b) positioning the valve element in the housing;
(c) positioning the spring over a stem of the valve element;
(d) positioning the spring retainer in alignment with the housing such that the spring rests between the valve element and the spring retainer;
(e) compressing the spring between the valve element and the spring retainer;
(f) rotating the spring retainer; and
(g) securing the at least one projection in a recess of the housing.

24. The method according to claim 23, wherein the step of compressing the spring includes the step of pressing the spring retainer towards the housing until the at least one projection rests against a body of the housing.

25. The method according to claim 23, and further including the step of releasing the spring retainer to allow the spring to expand and force the at least one projection into the recess.

26. The method according to claim 23, wherein the step of rotating the spring retainer includes the step of moving the at least one projection into a groove of the housing cooperating with the recess.

27. The method according to claim 23, wherein the housing includes a body and a pair of sidewalls, separated by opposing slots, extending outwardly therefrom, each of the sidewalls including a recess adjacent to and cooperating with a groove, and the spring retainer includes two projections extending outwardly from a flange of the spring retainer.

28. The method according to claim 27, wherein the steps of compressing, rotating, and securing include the steps of pressing the spring retainer towards the housing until the two projections are positioned within the slots and against the body, moving the two projections into the grooves until the projections are positioned below the recesses, releasing the spring retainer and allowing the spring to expand and force the projections upwardly into the recesses.
